(19) United States
(12) Patent Application Publication
(10) Pub. No.: US 2003/0095483 A1
(43) Pub. Date: May 22, 2003

(54) Optical disk player

(76) Inventor: Wei Xiong, Nagano (JP)

Correspondence Address: BIRCH STEWART KOLASCH & BIRCH, PO BOX 747, FALLS CHURCH, VA, 22040-0747, US

(21) Appl. No.: 10/281,314

(22) Filed: Oct. 28, 2002

(30) Foreign Application Priority Data
Nov. 19, 2001 (JP) 2001-352913

(51) Int. Cl. G11B 7/00

(52) U.S. Cl. 369/47.44; 369/53.35

(57) ABSTRACT

The optical disk player is capable of correctly reading audio data from a damaged optical disk and forwarding reliable audio data to a host computer. In the optical disk player, a spindle motor rotates the optical disk. A servo processor controls revolution of the spindle motor. An optical pick-up reads audio data from the optical disk. A decoder decodes the audio data read by the optical pick-up. A buffer memory buffers the audio data decoded by the decoder. A CPU detects errors of reading audio data and controls the servo processor. The control means controls the revolution control means to make a data reading velocity slower if the control means detects any error of reading audio data.

### BACKGROUND OF THE INVENTION

The present invention relates to an optical disk player capable of forwarding audio data.

Recording faces of optical disks, e.g., CD, CD-ROM, are often scratched or damaged. A method of reading audio data from a damaged optical disk is different from a method of reading data other than audio data therefrom.

In the case of reading data other than audio data from a CD-ROM, even 1 bit of data reading error is not allowed. Thus, if a data reading error is occurred by a scratch on the CD-ROM, a data reading velocity is made slower so as to securely read the data.

On the other hand, in the case of reading audio data from a damaged CD, 1 bit of data reading error does not influence reproduced sound. An optical disk player can correct the error on the basis of audio data located before and behind the error data. Therefore, audio data recorded on the damaged CD can be read without reducing the data reading velocity.

These days, the optical disk is rotated at high speed so as to accelerate the data reading velocity, so it is difficult to control revolution of a spindle motor. By accelerating the data reading velocity, acceleration torque and reduction torque of the spindle motor are insufficient, so it is difficult to control the high speed revolution of the spindle motor. Therefore, it is also difficult to securely read audio data from a damaged optical disk.

Note that, in the case of forwarding audio data, which have been read from an optical disk, to a host computer, the audio data read from the optical disk should be once buffered into a buffer memory.

However, when the buffered data are read, deviation of data addresses is rarely occurred due to uneven revolution of the spindle motor. Namely, if the damaged optical disk is rotated at high rotational speed, the uneven revolution of the spindle motor badly influences, so that the audio data cannot be read correctly. If the deviation of data address is occurred, tone quality of the reproduced sound is deteriorated.

Further, distortion of sub codes in audio data, which have been read from a damaged optical disk at high data reading velocity, are sometimes occurred when the audio data are buffered. If the distortion of sub codes is occurred, time data of the audio data are made incorrect.

In the case of reading audio data from a damaged optical disk, the number of times of retrying to read the audio data must be increased, so that time required to read the audio data must be longer.

### SUMMARY OF THE INVENTION

An object of the present invention is to provide an optical disk player capable of correctly reading audio data from a damaged optical disk and forwarding reliable audio data to a host computer.

To achieve the object, the present invention has following structures.

Namely, the optical disk player, which reads audio data written on an optical disk and forwards the audio data to a host computer, comprises:

a spindle motor for rotating the optical disk;

revolution control means for controlling revolution of the spindle motor;

an optical pick-up for reading audio data from the optical disk;

a decoder for decoding the audio data read by the optical pick-up;

a buffer memory for buffering the audio data decoded by the decoder; and

control means for detecting errors of reading audio data and controlling the revolution control means,

wherein the control means controls the revolution control means to make a data reading velocity slower if the control means detects any error of reading audio data.

In the optical disk player of the present invention, the data reading velocity is automatically made slower when the control means detects the reading errors, so audio data can be correctly read from a damaged optical disk.

In the optical disk player, the control mans may control the revolution control means to change the data reading velocity by stages.

In the optical disk player, the control means may control the revolution control means to make the data reading velocity slower one stage if the control means detects the error, and

the control means may repeat that control until the data reading velocity reaches the minimum data reading velocity.

With this structure, the data reading velocity can be automatically adjusted until reaching a proper velocity, so that audio data can be correctly read from a damaged disk.

In the optical disk player, the control means may control the revolution control means to make the data reading velocity faster one stage if the control means detects no error, and

the control means may repeat that control until the data reading velocity reaches the maximum data reading velocity.

With this structure, if the optical pick-up passes a damaged part of the optical disk and is capable of correctly reading audio data at high velocity, the data reading velocity can be automatically accelerated, so that a required time to read the audio data can be shortened.

In the optical disk player, the control means may read a group of the audio data at a first data reading velocity, then may read another group of the audio data at the same data reading velocity or at a second data reading velocity which is one stage faster than the first data reading velocity.

If the audio data are read at the maximum data reading velocity, probability of occurring errors of reading data is high. With this structure, an initial reading velocity is not the maximum velocity, so frequent occurrence of reading errors can be prevented even if the optical disk is the damaged disk. Therefore, the audio data can be smoothly read.

The optical disk player may further comprise means for detecting deviation of a data address and/or signal distortion when the audio data, which have been buffered in the buffer memory, are read, and

the control means may control the revolution control means to make the data reading velocity for rereading the audio data slower if the detecting means detects the deviation and/or signal distortion.

With this structure, even if the deviation and/or signal distortion are caused by the high data reading velocity, the control means can reduce the data reading velocity, so that the audio data can be correctly read.

### BRIEF DESCRIPTION OF THE DRAWINGS

Embodiments of the present invention will now be described by way of examples and with reference to the accompanying drawings, in which:

FIG. 1 is a block diagram of the optical disk player of a first embodiment of the present invention;

FIG. 2 is a flowchart showing action of the optical disk player of the first embodiment;

FIG. 3 is a block diagram of the optical disk player of a second embodiment of the present invention;

FIG. 4 is an explanation view showing data structures in a buffer memory;

FIGS. 5A-5C are flowcharts showing action of the optical disk player of the second embodiment;

FIG. 6 is a block diagram of the optical disk player of a third embodiment of the present invention;

FIG. 7 is a flowchart showing action of the optical-disk player of the third embodiment; and

FIG. 8 is a flowchart showing action of the optical disk player of a fourth embodiment.

### DETAILED DESCRIPTION OF THE EMBODIMENTS

Preferred embodiments of the present invention will now be described in detail with reference to the accompanying drawings.

### First Embodiment

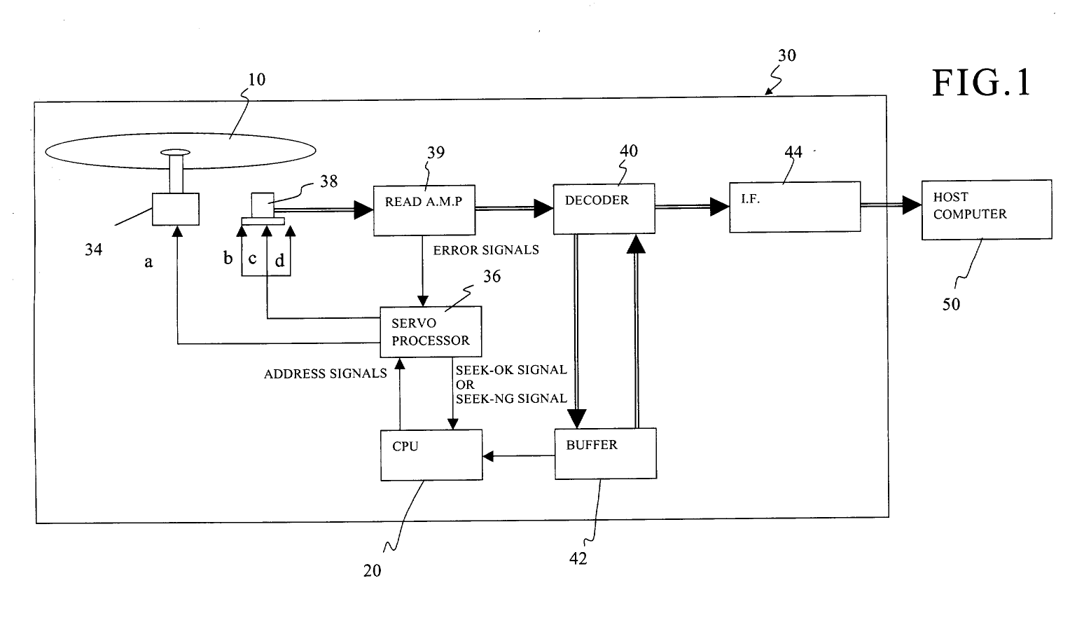

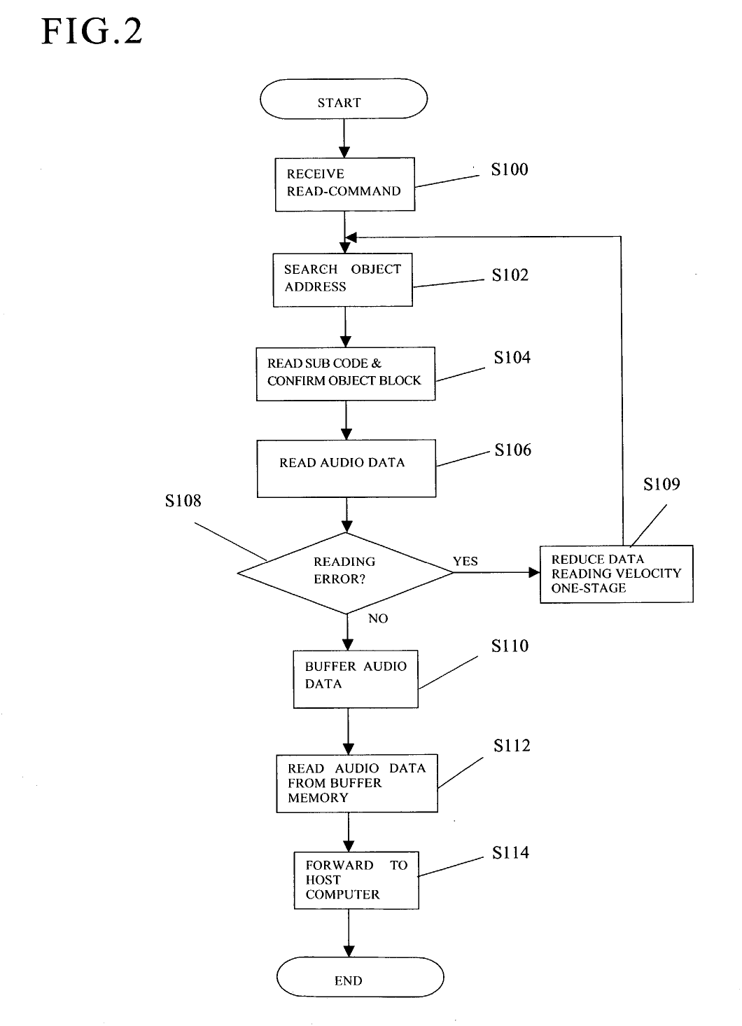

A first embodiment will be explained with reference to FIGS. 1 and 2. In FIG. 1, thick arrows indicate flows of data; thin arrows indicate flows of signals.

Note that, in the embodiments, audio data only are recorded on an optical disk 10, and an optical disk player 30 reads and forwards the audio data.

An optical disk 10 is attached to and rotated by a spindle motor 34. A servo processor 36 controls the spindle motor 34 to rotate the optical disk 10. The servo processor 36 sends motor control signals “a” to the spindle motor 34. In the present embodiment, the servo processor 36 acts as revolution control means.

An optical pick-up 38 reads audio data from the optical disk 10. The servo processor 36 further controls focusing and tracking an object lens (not shown) of the optical pick-up 38 and moving the optical pick-up 38. The servo processor 36 further generates focus control signals “b”, tracking control signals “c” and moving control signals “d”.

A read-amplifier 39 is connected to the optical pick-up 36. The read-amplifier 39 amplifies high frequency components of audio data read from the optical disk 10 and converts them into binary digital data. The read-amplifier 39 extracts error signals from the audio data read from the optical disk 10 and sends them to the servo processor 36 so as to execute the servo-control.

A decoder 40 is connected to the read-amplifier 39. The decoder 40 is capable of buffering digital data sent from the read-amplifier 39 into a buffer memory 42, reading data from the buffer memory 42 and sending the data read from the buffer memory 42 to an interface 44.

The buffer memory 42 buffers decoded audio data before forwarding. These days, high data reading velocity is required, so the buffer memory 42 is provided to stably continuously forward audio data read from the optical disk 10 to a host computer 50.

The interface 44, e.g., ATAPI (AT Attachment Packet Interface), SCSI (Small Computer System Interface), is provided to forward data to the host computer 50.

A CPU 20 acts as control means. The CPU 20 controls the servo processor 36 to read audio data from the optical disk 10 on the basis of programs stored in a memory, e.g., ROM.

The servo processor 36 controls the spindle motor 34 and the optical pick-up 38 on the basis of address signals sent from the CPU 20 so as to read audio data corresponding to the assigned addresses.

Next, action of the optical disk player 30 will be explained with reference to the flowchart of FIG. 2.

At a step S100, reading audio data from the optical disk 10 is started when a read-command is inputted by the host computer 50.

At a step S102, the servo processor 36 moves the optical pick-up 38 to an object address of the optical disk 10 assigned by the host computer 50.

At a step S104, the optical pick-up 38 reads sub codes at the object address and confirms a block to be read.

The “block” means a basic unit of reading audio data and has 2352 bytes. Note that, one block of audio data includes 98 CD frames, each of which is 24 bytes. A head of each CD frame includes a synchronous pattern and a sub coding, each of which has 8 bits. The sub coding includes channels “P”, “Q” and “R”. The channels “P”, “Q” and “R” of the sub codings of CD frames No. 3-96 are read to form sub codes “P”, “Q” and “R”. The channels “P” of the CD frames No. 3-96 constitute the sub code “P”; the channels “Q” of the CD frames No. 3-96 constitute the sub code “Q”; the channels “R” of the CD frames No. 3-96 constitute the sub code “R”.

At a step S106, the CPU 20 controls to read audio data corresponding to the sub codes read at the step S104.

At a step S108, if the optical disk 10 is scratched or damaged and the optical pick-up 38 cannot read audio data therefrom, a seek-NG signal is sent from the servo processor 38 to the CPU 20, then the CPU 20 goes to a step S109.

On the other hand, at the step S108, if no reading errors are detected, a seek-OK signal is sent from the servo processor 38 to the CPU 20, then the CPU 20 goes to a step S110.

At the step S109, the CPU 20 controls the servo processor 36 to reduce data reading velocity one stage and returns to the step S102. At the step S102, the CPU 20 controls to reread the data of the object address, at which the reading error has been occurred. For example in the case of occurring the reading error at 40×reading velocity, the reading velocity is reduced to 32×reading velocity to reread the data. Note that, if the reading error is occurred again at 32×reading velocity, the CPU 20 returns to the step S109 again to further reduce the reading velocity one stage.

In the present embodiment, the CPU 20 automatically repeats to reduce the data reading velocity until audio data can be correctly read.

On the other hand, at the step S110, if no reading errors are detected, audio data are decoded by the decoder 40 and buffered into the buffer memory 42.

The buffered audio data are read from the buffer memory 42 (a step S112) and forward to the host computer 50 via the decoder 40 and the interface 44 (a step S114).

### Second Embodiment

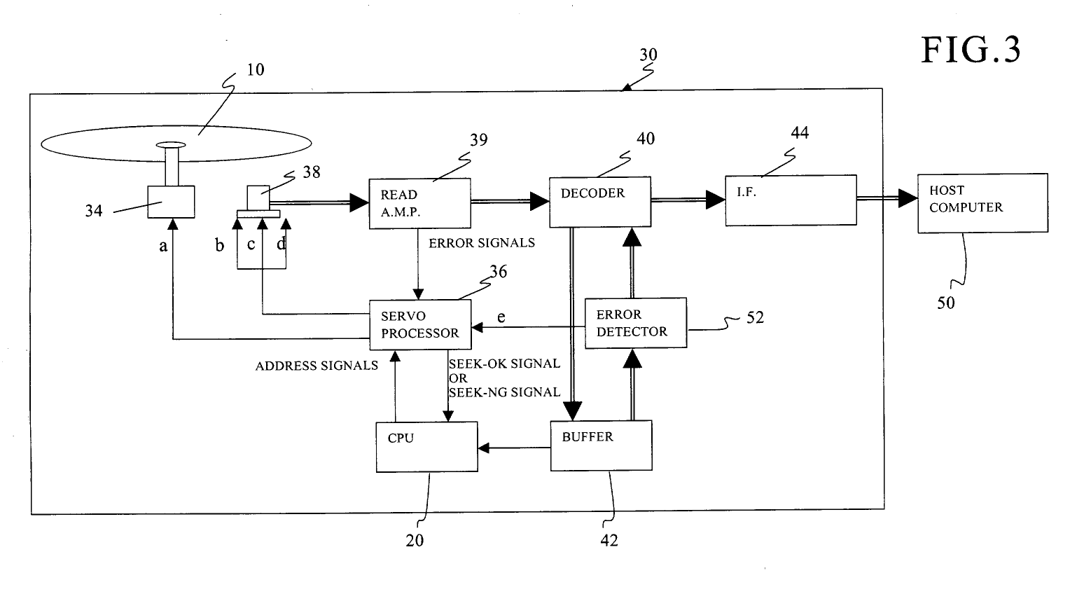

A second embodiment will be explained with reference to FIGS. 3, 4 and 5A-5C. Note that, the elements explained in the first embodiment are assigned the same symbols and explanation will be omitted.

In the optical disk player of the second embodiment, data deviation and/or signal distortion can be detected after the audio data are buffered.

An error detector 52 examines audio data extracted from the buffer memory 42 to check existence of data deviation and signal distortion. The error detector 52 acts as detecting means.

In the present embodiment, the error detector 52 includes a CPU capable of detecting data deviation and signal distortion. The CPU 20 or another CPU may be employed as the CPU of the error detector 52.

The error detector 52 checks if the data deviation and the signal distortion exists in the audio data read from the optical disk 10 or not. In the case of existing the data deviation and/or the signal distortion, the error detector 52 sends velocity control signals “e” to the servo processor 36 so as to reduce the data reading velocity.

Upon receiving the velocity control signals “e”, the servo processor 36 controls the spindle motor 34 to reduce the data reading velocity one stage.

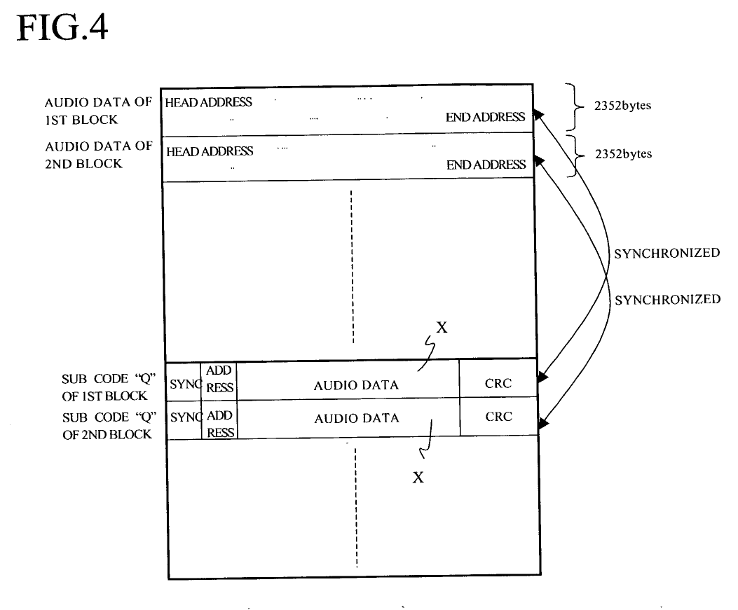

The action of detecting the data deviation will be explained with FIG. 4. FIG. 4 shows data structures in the buffer memory 42.

Note that, the buffer memory 42 is capable of detecting a head address of each block of audio data in the buffer memory 42.

Since data capacity of each block is 2352 bytes, the head address of each block must be equal to a multiple of the number 2352. The error detector 52 checks if the head address of each block is a multiple of the number 2352 or not.

If the error detector 52 judges that the head address of the block is not a multiple of the number 2352, data deviation (or address deviation) is occurred in the audio data.

In the case of detecting the data deviation, the servo processor 36 reduces the data reading velocity and rereads the audio data. Note that, all of the blocks buffered in the buffer memory 42 are examined at a time.

Successively, a method of detecting the signal distortion by the error detector 52 will be explained with reference to FIG. 4. As an example, a method of detecting the signal distortion of the sub code “Q”, which has been synchronously buffered with audio data, will be explained.

Firstly, a structure of the sub code “Q” will be explained. The sub codes “Q” are provided to indicate time and scan music. An example is shown in FIG. 4.

“Sync”, which is provided to a head of each sub code “Q” and has size of 4 bits, is provided to identify number of channels, emphases, etc. “Address”, which is next after the “Sync” and has size of 4 bits, is provided to identify a manufacturer and a data mode.

Audio data “x” has size of 72 bits and includes a number of movement, index, time elapsed in a movement (Minute Second Frame), absolute time (Minute Second Frame), etc.

“CRC (Cyclic Redundancy Code)” is provided to correct errors in the data “x”.

The error detector 52 reads data included in the sub code “Q” and calculates a value of CRC on the basis of said data. Further, the error detector 52 compares the calculated value of the CRC and a stored value of the CRC, which has been actually stored in the buffer memory 42.

Namely, the error detector 52 detects signal distortion in the data “x” of the sub code “Q”. As a result of the comparison, if the calculated CRC equals to the stored CRC, no signal distortion is occurred in the sub code “Q”.

On the other hand, the error detector 52 judges that the calculated CRC is different from the stored CRC, the buffered signals are distorted. Namely, the signal distortion is occurred in the sub code “Q”.

If the error detector 52 detects the signal distortion in the sub code “Q”, the data reading velocity is reduced and the audio data are reread. Detecting the signal distortion in the sub codes “Q” on the basis of the CRC values is executed for each block.

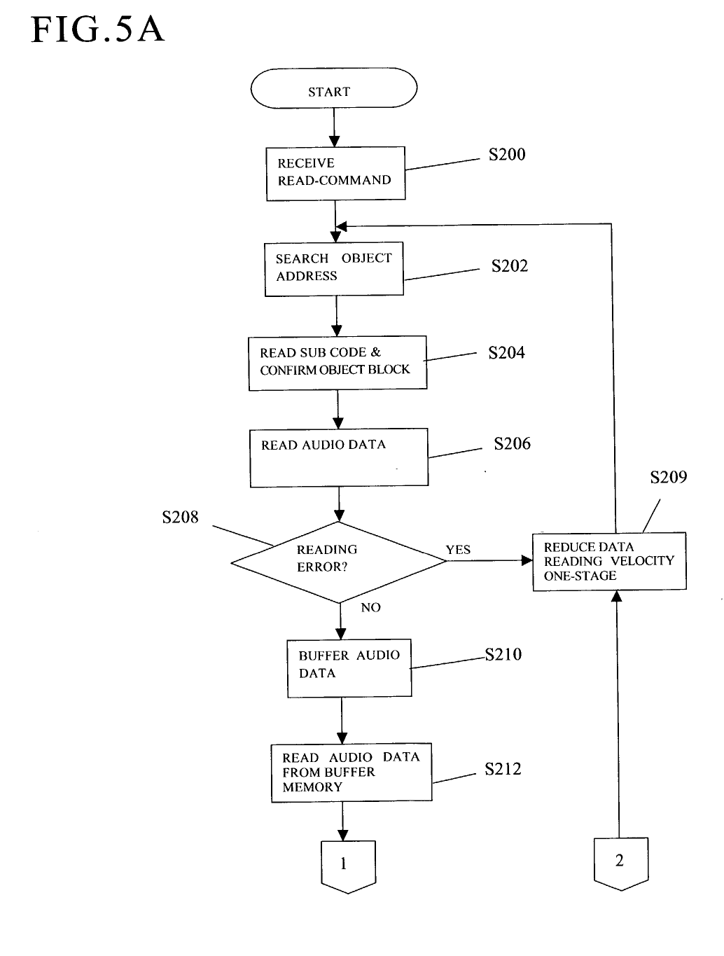

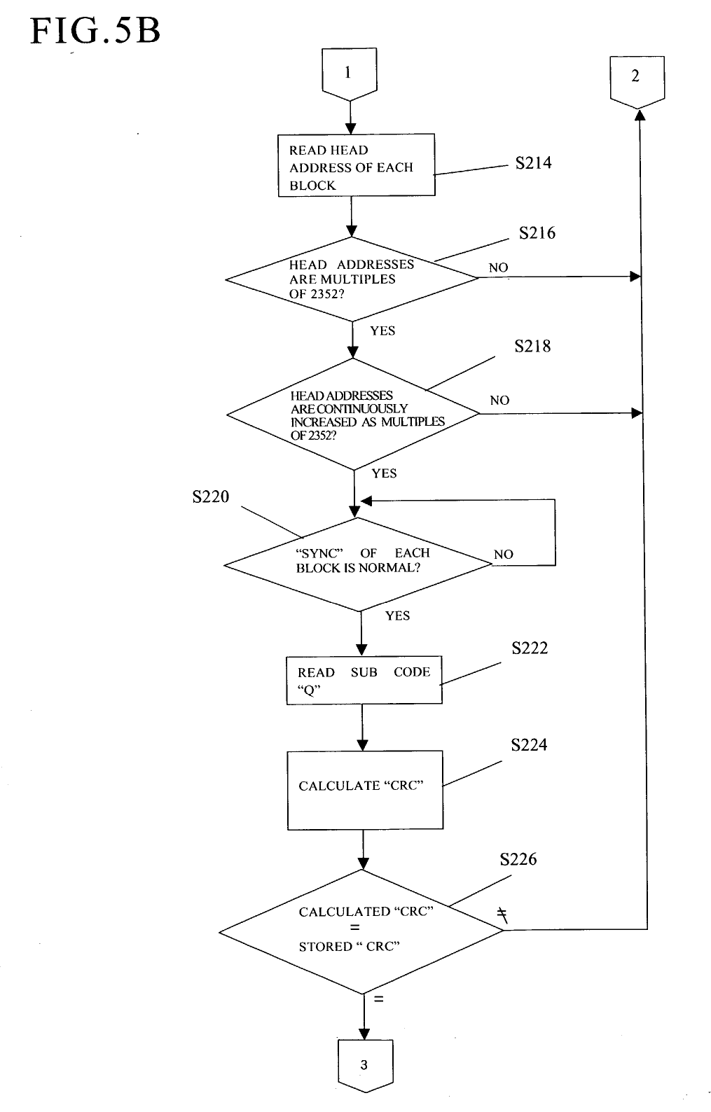

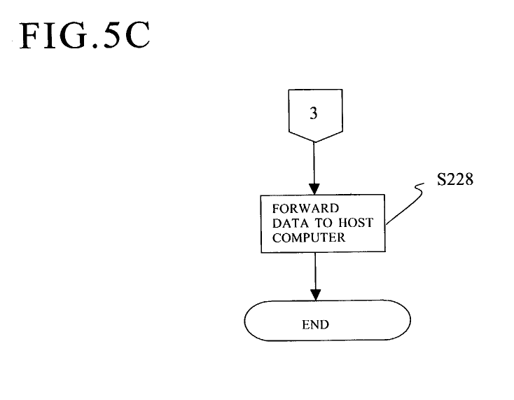

The action of the optical disk player 30 of the second embodiment will be explained with reference to FIGS. 5A-5C.

At a step S200, reading audio data from the optical disk 10 is started when a read-command is inputted by the host computer 50.

At a step S202, the servo processor 36 moves the optical pick-up 38 to an object address of the optical disk 10 assigned by the host computer 50.

At a step S204, the optical pick-up 38 reads sub codes at the object address and confirms a block to be read.

At a step S206, the CPU 20 controls to read audio data corresponding to the sub codes read at the step S204.

At a step S208, if the optical disk 10 is scratched or damaged and the optical pick-up 38 cannot read audio data therefrom, the seek-NG signal is sent from the servo processor 38 to the CPU 20, then the CPU 20 goes to a step S209.

On the other hand, at the step S208, if no reading errors are detected, the seek-OK signal is sent from the servo processor 38 to the CPU 20, then the CPU 20 goes to a step S210.

At the step S209, the CPU 20 controls the servo processor 36 to reduce data reading velocity one stage and returns to the step S202. At the step S202, the CPU 20 controls to reread the data of the object address, at which the reading error has been occurred.

On the other hand, at the step S210, if no reading errors are detected, audio data are decoded by the decoder 40 and buffered into the buffer memory 42.

The buffered audio data are read from the buffer memory 42 (a step S212), then the data deviation and the signal distortion of the buffered data are-detected by the error detector 52 at a step S214.

At the step S214, the buffer memory 42 reads the head address of each block.

At a step S216, the error detector 52 checks if the head address of each block is the multiple of 2352 or not. If any head address is not the multiple of 2352, the data deviation has been occurred, so the CPU 20 returns to the step S209.

At a step S218, the error detector 52 checks if the head addresses of all the blocks are continuously increased as the multiples of 2352 or not. If the head addresses are not continuously increased as the multiples of 2352, the data deviation has been occurred while buffering data, so the CPU 20 returns to the step S209.

At a step S220, the error detector 52 checks if the “Sync” of the sub code “Q” of each block is normal or not.

At a step S222, the error detector 52 reads the data “x” of the sub codes “Q”.

At a step S224, the error detector 52 calculates the CRC value on the basis of the data “x” of the sub codes “Q”, which have been buffered.

At a step S226, the error detector 52 reads the stored CRC from the buffer memory 42 and compares the stored CRC with the calculated CRC, which has been calculated at the step S224.

The CRC stored in the buffer memory 42 has been checked by the decoder 40, so it should be equal to the calculated CRC. But, if signal distortion is occurred, the stored CRC is not equal to the calculated CRC.

If the CRC values are not equal, the signal distortion of the sub code “Q” has been occurred while buffering the data, so the CPU 20 returns to the step S209. On the other hand, if the CRC values are equal, the CPU 20 goes to a sep S228.

At the step S228, the audio data read from the buffer memory 42 are forward to the host computer 50 via the decoder 40 and the interface 44.

### Third Embodiment

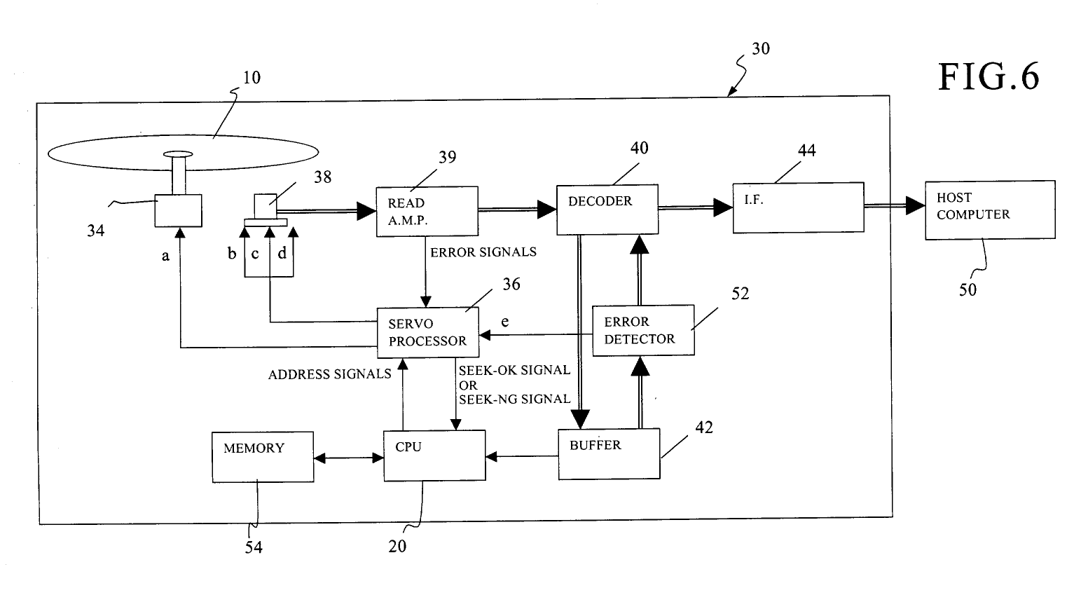

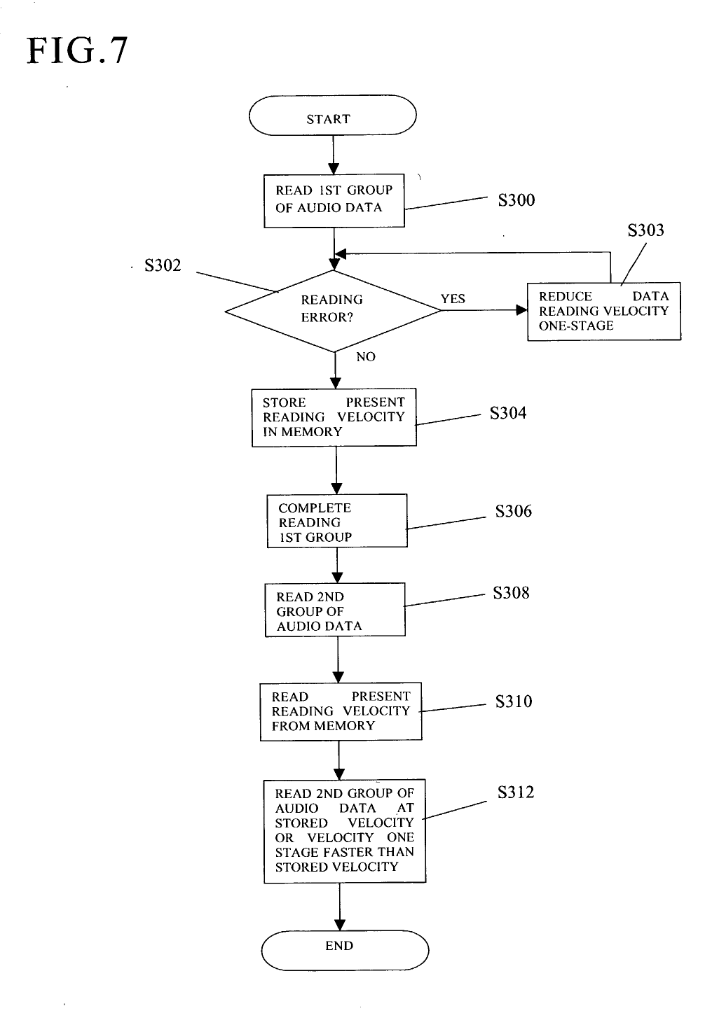

A third embodiment will be explained with reference to FIGS. 6 and 7. Note that, the elements explained in the foregoing embodiments are assigned the same symbols and explanation will be omitted.

In the optical disk player of the third embodiment, the CPU 20 reads a first group of the audio data at a first data reading velocity, then reads a second group of the audio data at the same data reading velocity or at a second data reading velocity which is one stage faster than the first data reading velocity.

A memory 54, e.g., RAM, is connected to the CPU 20. A former data reading velocity is stored in the memory 54. The memory 54 may be employed in the optical disk player of the first and the second embodiments.

Action of the third embodiment will be explained with reference to FIG. 7. Note that, the steps explained in the former embodiments are omitted in the present embodiment.

At a step S300, reading a first group of audio data is started.

If there is a scratch in the vicinity of an object address of the optical disk 10, a reading error is detected at a step S302. In the case of detecting the reading error at the step S302, the CPU 20 goes to a step S303.

At the step S303, the CPU 20 controls the servo processor 36 to reduce the data reading velocity one stage. In this state, the CPU 20 searches the object address, at which the reading error has been occurred, again.

In the case no error is detected at the step S302, the present data reading velocity is stored in the memory 54 as a first data reading velocity.

If the reading error was detected at the step S302, the present velocity stored in the memory 54 is the data-readable velocity reduced at the step S303. If no errors were detected, the stored velocity is the maximum velocity.

At a step S306, reading the first group of audio data is completed.

At a step S308, reading a second group of audio data is started when the host computer sends the read-command.

At a step S310, the CPU 20 reads the present data reading velocity, at which the first group of audio data have been correctly read, from the memory 54.

At a sep S312, the CPU 20 controls the servo processor 36 to read the second group of audio data at the first data reading velocity or a second data reading velocity, which is one stage faster than the first data reading velocity.

In the case that a plurality of groups of audio data are read from one optical disk, the data reading velocity for the present group can be defined on the basis of the velocity for the foregoing group. Therefore, the audio data can be read at a proper velocity from the beginning even if probability of occurring errors of reading data is high.

### Fourth Embodiment

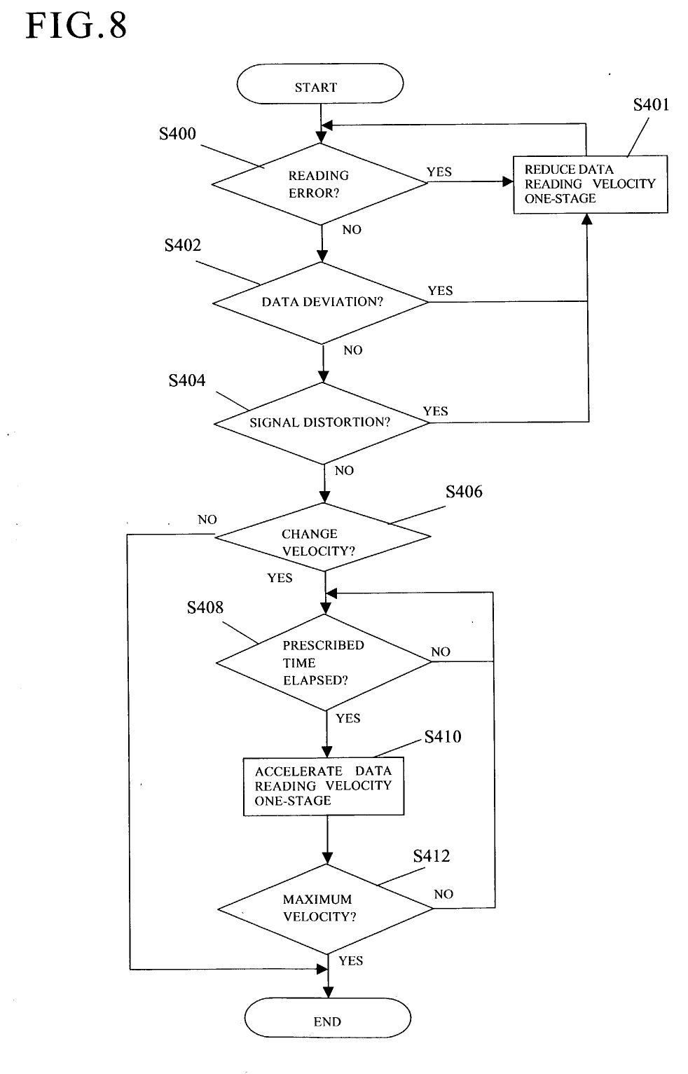

A fourth embodiment will be explained with reference to FIG. 8.

In the fourth embodiment, the data reading velocity is once reduced, then accelerated at stages if no reading errors are detected within a prescribed time.

Note that, the elements explained in the foregoing embodiments are assigned the same symbols and explanation will be omitted.

In the present embodiment, if data reading errors, data deviation and signal distortion are detected, the data reading velocity is reduced one stage as well as the second embodiment. Note that, methods of reading data and detecting data deviation and signal distortion are the same as those of the foregoing embodiments, so explanation will be omitted.

At a step S400, if a reading error is occurred due to a scratch in the vicinity of an object address, the CPU 20 goes to a step S401 and controls the servo processor 36 to reduce the data reading velocity one stage. Then, the CPU 20 returns to the step S400 to search the object address again.

On the other hand, at the step S400, if no errors are detected from the beginning or no errors are detected at the reduced velocity, the CPU 20 goes to a step S402.

At a step S402, the error detector 52 checks existence of data deviation of audio data stored in the buffer memory 42. If the error detector 52 detects any data deviation, the CPU 20 goes to the step S401 and controls the servo processor 36 to reduce the data reading velocity one stage. Then, the CPU 20 returns to the step S400 to search the object address again.

On the other hand, if the error detector 52 detects no data deviation, the CPU 20 goes to a step S404.

At a step S404, the error detector 52 checks existence of signal distortion of audio data stored in the buffer memory 42. In the present embodiment, signal distortion in the sub code “Q” is checked. If the error detector 52 detects any signal distortion, the CPU 20 goes to the step S401 and controls the servo processor 36 to reduce the data reading velocity one stage. Then, the CPU 20 returns to the step S400 to search the object address again.

On the other hand, if the error detector 52 detects no signal distortion, the CPU 20 goes to a step S406.

At a step S406, if the data reading velocity has been changed, the CPU 20 goes to a step S408. On the other hand, if the data reading velocity has not been changed and audio data can be read at the maximum reading velocity, the CPU 20 continues to read data at the maximum velocity.

At a step S408, the CPU 20 checks if a prescribed time elapsed from changing velocity or not. If the prescribed time elapsed, the CPU 20 judges that the optical pick-up 38 has passed the scratched part and the data reading velocity can be accelerated. Therefore, the CPU 20 goes to a step S410 to control the servo processor 36 to accelerate the data reading velocity one stage.

In the present invention, the optical disk player must have a function of reproduce audio data, but a function of recording data is not required.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. An optical disk player, which reads audio data written on an optical disk and forwards the audio data to a host computer,
comprising:
a spindle motor for rotating the optical disk;
revolution control means for controlling revolution of said spindle motor;
an optical pick-up for reading audio data from the optical disk;
a decoder for decoding the audio data read by said optical pick-up;
a buffer memory for buffering the audio data decoded by said decoder; and
control means for detecting errors of reading audio data and controlling said revolution control means,
wherein said control means controls said revolution control means to make a data reading velocity slower if said control means detects any error of reading audio data.

2. The optical disk player according to claim 1,
wherein said control mans controls said revolution control means to change the data reading velocity by stages.

3. The optical disk player according to claim 2,
wherein said control means controls said revolution control means to make the data reading velocity slower one stage if said control means detects the error, and
said control means repeats that control until the data reading velocity reaches the minimum data reading velocity.

4. The optical disk player according to claim 2,
wherein said control means controls said revolution control means to make the data reading velocity faster one stage if said control means detects no error, and
said control means repeats that control until the data reading velocity reaches the maximum data reading velocity.

5. The optical disk player according to claim 2,
wherein said control means reads a group of the audio data at a first data reading velocity, then reads another group of the audio data at the same data reading velocity.

6. The optical disk player according to claim 2,
wherein said control means reads a group of the audio data at a first data reading velocity, then reads another group of the audio data at a second data reading velocity which is one stage faster than the first data reading velocity.

7. The optical disk player according to claim 1,
further comprising means for detecting deviation of a data address when the audio data, which have been buffered in said buffer memory, are read,
wherein said control means controls said revolution control means to make the data reading velocity for rereading the audio data slower if said detecting means detects the deviation.

8. The optical disk player according to claim 1,
further comprising means for detecting signal distortion when the audio data, which have been buffered in said buffer memory, are read,
wherein said control means controls said revolution control means to make the data reading velocity for rereading the audio data slower if said detecting means detects the signal distortion.
